(19) United States
(12) Patent Application Publication
(10) Pub. No.: US 2026/0291044 A1
(43) Pub. Date: Sep. 24, 2026

(54) WAVEGUIDE DEVICE, MICROWAVE OUTDOOR UNIT, AND LONG-HAUL MICROWAVE TRANSMISSION DEVICE

(71) Applicant: Huawei Technologies Co., Ltd., Shenzhen (CN)

(72) Inventors: Xuejiao Li, Shanghai (CN); Leilei Tian, Xi'an (CN); Wenqin Yan, Xi'an (CN); Guoxiang Cao, Xi'an (CN); Changliang Li, Shenzhen (CN); Tengteng Ji, Xi'an (CN)

(21) Appl. No.: 19/678,502

(22) Filed: May 15, 2026

Related U.S. Application Data
(63) Continuation of application No. PCT/CN2023/132324, filed on Nov. 17, 2023.

(51) Int. Cl. H01P 3/123; H01F 7/02; H01P 1/36; H01P 1/38

(52) U.S. Cl. CPC H01P 3/123; H01F 7/0205; H01P 1/36; H01P 1/38

(57) ABSTRACT

A waveguide device is provided in this application. The waveguide device includes a body, a cover plate, a ridge structure, a ferrite, a permanent magnet, and a tuning member. The body includes a first surface and a second surface that are opposite to each other. A chamber is provided on the first surface. The cover plate is arranged on the first surface of the body, and covers the chamber. The ridge structure is arranged in the chamber. The ferrite is arranged on the ridge structure. The permanent magnet is arranged on the second surface of the body.

### CROSS-REFERENCE TO RELATED APPLICATIONS

This application is a continuation of International Patent Application No. PCT/CN2023/132324, filed on Nov. 17, 2023, the disclosure of which is hereby incorporated by reference in its entirety.

### TECHNICAL FIELD

This application relates to the field of communication technologies, and in particular, to a waveguide device, a microwave outdoor unit, and a long-haul microwave transmission device.

### BACKGROUND

With the development of microwave communication technologies, a microwave point-to-point backhaul communication technology has emerged and has received extensive attention by virtue of a large capacity of microwave communication frequency bands.

A waveguide circulator/isolator is one of key devices in a microwave point-to-point backhaul communication system. The waveguide circulator/isolator is a directional frequency selective device configured for unidirectional transmission of a radio frequency signal.

Currently, the waveguide circulator/isolator commonly uses ferrite resonance. However, due to impact of high-order harmonic waves and cutoff frequencies, a relative bandwidth of an operating frequency of the waveguide circulator/isolator is limited, generally ranging from approximately 15% to 40%, which cannot meet requirements of an ultra-wideband application scenario.

### SUMMARY

Embodiments of this application provide a waveguide device, a microwave outdoor unit, and a long-haul microwave transmission device, to expand a bandwidth of an operating frequency.

To achieve the foregoing objective, the following technical solutions are used in embodiments of this application.

According to a first aspect, a waveguide device is provided. The waveguide device may be used as a waveguide isolator, or may be used as a waveguide circulator. The waveguide device includes a cavity, a cover plate, a ridge structure, a ferrite, a permanent magnet, and a tuning member. The cavity includes a first surface and a second surface that are opposite to each other. A chamber is provided on the first surface. The cover plate is arranged on the first surface of the cavity, and covers the chamber. The ridge structure is arranged in the chamber. The ferrite is arranged on the ridge structure. The permanent magnet is arranged on the second surface of the cavity. The tuning member is also arranged on the ridge structure, and is spaced apart from the ferrite. The tuning member includes a top surface away from the second surface. The ridge structure includes a top surface away from the second surface. The top surface of the tuning member is higher than the top surface of the ridge structure.

According to the waveguide device provided in the foregoing embodiment of this application, the ridge structure is arranged in the chamber, and the ridge structure and the chamber may form a resonant cavity in a form of a ridge waveguide. The ferrite is arranged on the ridge structure, the ferrite has a magnetic rotation characteristic, the permanent magnet is arranged on the second surface of the cavity, and the ferrite may be magnetized under the action of a magnetic field of the permanent magnet, to maintain the magnetic rotation characteristic. Under the action of the ferrite and the permanent magnet, unidirectional transmission of a radio frequency signal in the resonant cavity in the form of the ridge waveguide is implemented.

In addition, the tuning member is arranged on the ridge structure, and the tuning member is spaced apart from the ferrite. In this way, the tuning member is coupled to the ridge structure. The tuning member is introduced into the resonant cavity in the form of the ridge waveguide in which the ridge structure is located. This is equivalent to a case in which the tuning member is coupled to the waveguide isolator. The tuning member may introduce an in-band resonance point, to generate a quasi-transverse electromagnetic mode resonance. The tuning member and the resonant cavity in the form of the ridge waveguide may achieve a multi-resonance effect, thereby facilitating adjustment of a frequency of the radio frequency signal transmitted by the waveguide isolator, and helping expand a bandwidth of an operating frequency.

In addition, a height of the top surface of the tuning member is adjusted to adjust a height of the top surface of the tuning member relative to the top surface of the ridge structure, so that a resonance frequency of the tuning member may be adjusted, and the frequency of the radio frequency signal transmitted by the waveguide isolator may also be adjusted, thereby helping expand the bandwidth of the operating frequency.

In some embodiments, the chamber includes a plurality of channels, and ends of the plurality of channels are in communication with each other. Each channel is provided with one ridge structure, and a plurality of ridge structures in the plurality of channels are connected at a position of communication of the plurality of channels. At least one tuning member is arranged on the ridge structure in each channel.

It may be understood that, a larger quantity of tuning members arranged on each ridge structure indicates more introduced in-band resonance points, and a clearer multi-resonance effect in the resonant cavity in the form of the ridge waveguide. This helps expand the bandwidth of the operating frequency.

In some embodiments, the ridge structure includes a plurality of sub-ridge structures, and the plurality of sub-ridge structures are successively connected along a length extension direction of the channel. The plurality of sub-ridge structures include top surfaces away from the second surface, and along a direction away from the position of communication of the plurality of channels, heights of the top surfaces of the plurality of sub-ridge structures relative to the second surface decrease successively, and the top surfaces of the plurality of sub-ridge structures form a plurality of steps. A plurality of tuning members are arranged on the ridge structure in each channel, and the plurality of tuning members are arranged on a same step, or the plurality of tuning members may be arranged on different steps.

In some embodiments, it is assumed that a wavelength of the radio frequency signal transmitted by the waveguide device is λ, and on the ridge structure in each channel, a spacing between two adjacent tuning members is less than or equal to λ/4 along a direction parallel to the second surface. The ferrite is arranged at a joint of the plurality of ridge structures in the plurality of channels. A spacing between a tuning member that is in the plurality of tuning members on the ridge structures and that is closest to the ferrite and the ferrite is less than or equal to λ/4 along the direction parallel to the second surface, to ensure that a coupling amount between the plurality of tuning members is large enough, so as to meet a requirement for expanding the bandwidth of the operating frequency.

In some embodiments, the tuning member is movably connected to the ridge structure, to facilitate adjustment of a vertical distance between the top surface of the tuning member and the top surface of the ridge structure, so that the resonance frequency of the tuning member may be adjusted.

In some embodiments, the tuning member is threadedly connected to the ridge structure. This is highly feasible for engineering implementation and is suitable for mass production. In addition, a height of the tuning member may be adjusted by rotating the tuning member, so that the resonance frequency of the tuning member may be adjusted.

In some embodiments, the tuning member is obtained through machining on the ridge structure. The tuning member and the ridge structure are integrally formed. This is also highly feasible for engineering implementation and is suitable for mass production.

In some embodiments, a shape of an orthographic projection of the tuning member on the second surface includes a circle or a polygon.

In some embodiments, each channel includes a plurality of resonant cavities that are in communication with each other. In at least two resonant cavities that are in communication with each other, one resonant cavity is provided with the ridge structure and the tuning member, the other resonant cavity is provided with a resonant member, and the resonant member is connected to the ridge structure. Inductive coupling of the two resonant cavities is implemented through the ridge structure. This helps expand the bandwidth of the operating frequency.

In some embodiments, a shape of the resonant member includes a cylinder, a shape of the resonant cavity in which the resonant member is located includes a cylinder, and the resonant member and the resonant cavity are coaxially arranged.

In some embodiments, the chamber of the cavity includes three channels, and orthographic projections of the three channels on the second surface are Y-shaped or T-shaped.

According to a second aspect, a waveguide circulator is provided. The waveguide circulator includes the waveguide device in any one of the foregoing embodiments. In the chamber of the cavity of the waveguide circulator, each channel is provided with one port, and the port extends through the cavity.

In a process in which the waveguide circulator transmits or receives a radio frequency signal, the radio frequency signal is input to the port of any channel. The radio frequency signal may be unidirectionally transmitted to any other channel in a determined order under the action of the ferrite and the permanent magnet, and output through the port of the channel.

According to a third aspect, a waveguide isolator is provided. The waveguide isolator includes the waveguide device in any one of the foregoing embodiments. In the chamber of the cavity of the waveguide isolator, one of the plurality of channels is provided with a wave-absorbing load structure, each of the remaining channels is provided with one port, and the port extends through the cavity.

In a process in which the waveguide isolator transmits or receives a radio frequency signal, the radio frequency signal may be input from a port of one channel, unidirectionally transmitted to another channel under the action of the ferrite and the permanent magnet, and output from the port of the channel. All radio frequency signals reflected back by the ports of the channels may be absorbed and consumed by the wave-absorbing load structure, thereby implementing reverse isolation of the radio frequency signals.

According to a fourth aspect, a microwave outdoor unit is provided. The microwave outdoor unit is an outdoor module that processes, transmits, and receives a radio frequency signal, and is a core unit of a microwave point-to-point backhaul communication system. The microwave outdoor unit includes a lower box body, a box cover, a circuit board, a shielding cover, a duplexer, and the waveguide isolator in the foregoing embodiments. The box cover is arranged on the lower box body. The box cover and the lower box body may form a container. The circuit board, the shielding cover, and the duplexer are arranged in the container. The shielding cover and the duplexer are successively arranged on the circuit board. The duplexer is connected to the box cover. The waveguide isolator is integrated onto the shielding cover.

In a process in which the microwave outdoor unit transmits the radio frequency signal, the radio frequency signal is output from the circuit board, transmitted to the waveguide isolator on the shielding cover through the port, transmitted to the duplexer through the port, and finally transmitted through a common port by using an external antenna.

In a process in which the microwave outdoor unit receives the radio frequency signal, the radio frequency signal is received through the external antenna. The radio frequency signal is input to the duplexer through the common port, transmitted to the waveguide isolator on the shielding cover through the port, and transmitted to the circuit board through the port.

According to a fifth aspect, a long-haul microwave transmission device is provided. The long-haul microwave transmission device is used in a long-haul microwave communication transmission scenario, is usually in a low frequency band of microwaves, and has performance features such as multi-channel, large-capacity, and long-haul transmission. In terms of a product form, the long-haul microwave transmission device uses a design in which a microwave radio frequency unit is separated from a microwave branching unit, so that multi-channel frequencies can be flexibly combined, and limited frequency resources of microwaves in a low frequency band are fully used, thereby achieving a high link capacity.

The microwave radio frequency unit includes a lower box body, a box cover, a circuit board, a shielding cover, and the waveguide isolator in the foregoing embodiments. The box cover is arranged on the lower box body. The box cover and the lower box body may form a container. The circuit board, the shielding cover, and the waveguide isolator are all arranged in the container. The shielding cover and the waveguide isolator are successively arranged on the circuit board. The waveguide isolator is connected to the box cover. The microwave branching unit is arranged on the microwave radio frequency unit, and the microwave branching unit is connected to the waveguide isolator through the box cover.

In a process in which the microwave radio frequency unit transmits a radio frequency signal, the radio frequency signal is transmitted from the circuit board to the shielding cover, transmitted to the waveguide isolator through a port, and finally transmitted through the port.

In a process in which the microwave radio frequency unit receives a radio frequency signal, the radio frequency signal is input to the waveguide isolator through the port, transmitted to the shielding cover through the port, and transmitted from the shielding cover to the circuit board.

The microwave branching unit is arranged on the microwave radio frequency unit, and the microwave branching unit is connected to the waveguide isolator through the box cover. For example, the microwave branching unit is connected to the waveguide isolator through the port.

According to a sixth aspect, a long-haul microwave transmission device is provided. The long-haul microwave transmission device also includes a microwave radio frequency unit and a microwave branching unit. The microwave branching unit is arranged on the microwave radio frequency unit. The microwave branching unit includes the waveguide circulator in the foregoing embodiments.

It may be understood that, for beneficial effects that can be achieved by the microwave outdoor unit and the long-haul microwave transmission device provided in the foregoing embodiments of this application, refer to the beneficial effects of the foregoing waveguide device. Details are not described herein again.

### BRIEF DESCRIPTION OF THE DRAWINGS

To describe technical solutions in this application more clearly, the following briefly describes the accompanying drawings required for describing some embodiments of this application. It is clear that the accompanying drawings in the following descriptions are merely accompanying drawings in some embodiments of this application. A person of ordinary skill in the art may further derive other accompanying drawings from these accompanying drawings. In addition, the accompanying drawings in the following descriptions may be considered as diagrams, and are not intended to limit actual sizes of products in embodiments of this application.

FIG. 1 and FIG. 2 are a three-dimensional structural diagram of a waveguide isolator according to an embodiment of this application;

FIG. 3 is a top view of the waveguide isolator in FIG. 2;

FIG. 4 is a bottom view of the waveguide isolator in FIG. 2;

FIG. 5 is a diagram of an equivalent circuit of a resonance generation mechanism of a tuning member according to an embodiment of this application;

FIG. 6 is a curve diagram of a simulated scattering parameter of a waveguide isolator according to an embodiment of this application;

FIG. 7 is another three-dimensional structural diagram of a waveguide isolator according to an embodiment of this application;

FIG. 8 is still another three-dimensional structural diagram of a waveguide isolator according to an embodiment of this application;

FIG. 9 is a top view of a waveguide circulator according to an embodiment of this application;

FIG. 10 is a bottom view of a waveguide circulator according to an embodiment of this application;

FIG. 11 is a diagram of a structure of a microwave outdoor unit according to an embodiment of this application;

FIG. 12 is a diagram of a structure of a long-haul microwave transmission device according to an embodiment of this application; and

FIG. 13 is a diagram of an architecture of a microwave branching unit according to an embodiment of this application.

### DETAILED DESCRIPTION OF ILLUSTRATIVE EMBODIMENTS

Technical solutions in some embodiments of this application are described below with reference to the accompanying drawings. It is clear that the described embodiments are merely some rather than all of embodiments of this application. All other embodiments obtained by a person of ordinary skill in the art based on embodiments provided in this application fall within the protection scope of this application.

With reference to an electromagnetic field theory and a filter coupling resonance mechanism, embodiments of this application provide a waveguide device in a form of a multi-resonance ultra-wideband resonant cavity. The waveguide device may be used as a waveguide isolator, or may be used as a waveguide circulator.

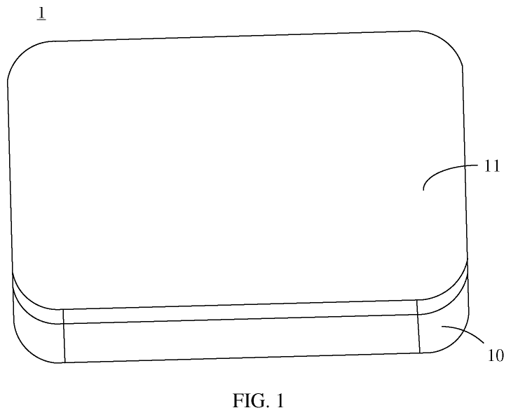

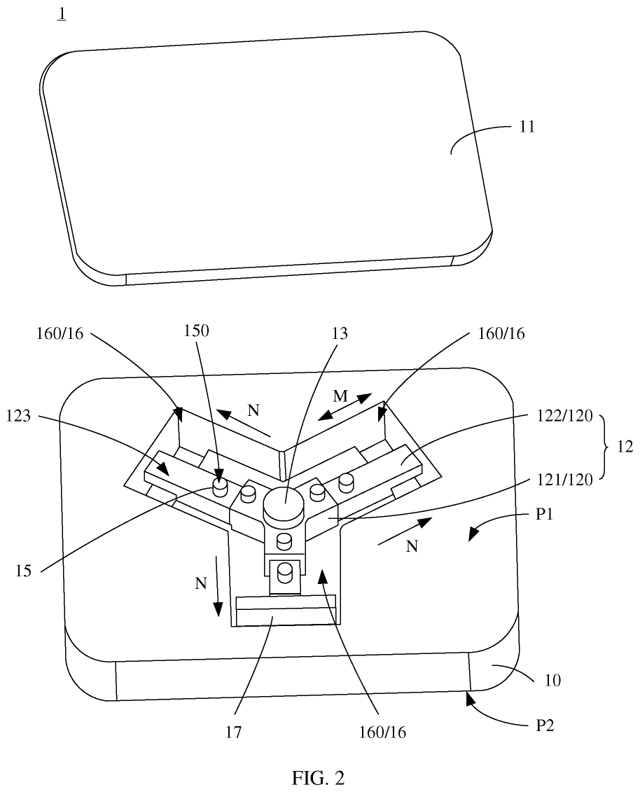

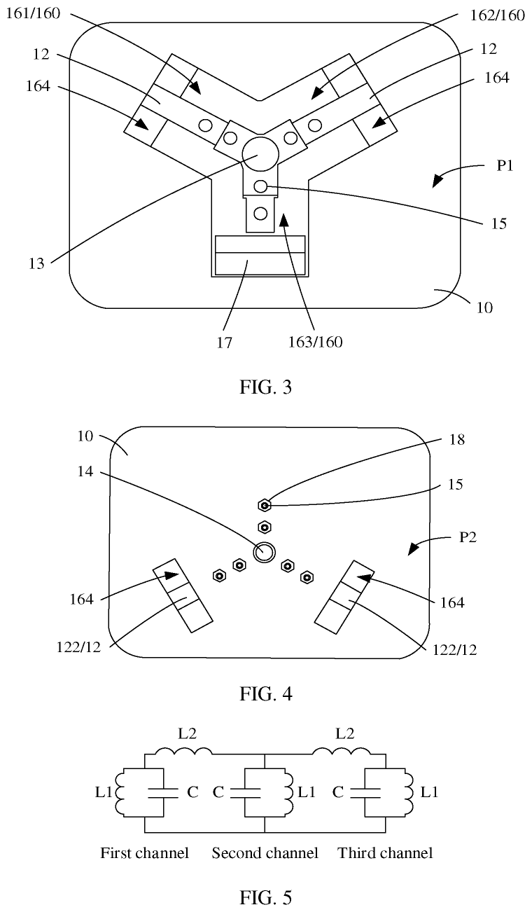

FIG. 1 and FIG. 2 are a three-dimensional structural diagram of a waveguide isolator according to an embodiment of this application. FIG. 3 is a top view of the waveguide isolator in FIG. 2. FIG. 4 is a bottom view of the waveguide isolator in FIG. 2.

Refer to FIG. 1 to FIG. 4. The waveguide isolator 1 includes a cavity 10, a cover plate 11, a ridge structure 12, a ferrite 13, a permanent magnet 14, and a tuning member 15.

Refer to FIG. 2. The cavity 10 includes a first surface P1 and a second surface P2 that are opposite to each other. For example, the first surface P1 and the second surface P2 are located on two opposite sides of the cavity 10 along a thickness direction of the cavity 10. The first surface P1 of the cavity 10 is recessed downward, to form a chamber 16 inside the cavity 10.

For example, the chamber 16 includes a plurality of channels 160. Ends of the plurality of channels 160 are in communication with each other. Generally, the chamber 16 includes three channels 160 that are in communication with each other.

Refer to FIG. 1 and FIG. 2. The cover plate 11 is arranged on the first surface P1 of the cavity 10. In other words, the cover plate 11 covers the first surface P1 of the cavity 10, and covers the chamber 16 of the cavity 10, so that the chamber 16 forms a resonant cavity. A manner of connecting the cover plate 11 to the cavity 10 is not limited in this application. The cover plate 11 and the cavity 10 may be fastened through a screw, or may be bonded.

Refer to FIG. 2. The ridge structure 12 is arranged in the chamber 16. The ridge structure 12 and the chamber 16 may form a resonant cavity in a form of a ridge waveguide. The resonant cavity may be filled with a dielectric material, or may be filled with air (not filled with a dielectric material). The resonant cavity is configured to transmit a radio frequency signal. The waveguide isolator 1 uses such a resonant cavity design. This helps reduce a volume of a device, reduce preparation costs of the device, and improve signal transmission performance of the device.

For example, each channel 160 is provided with one ridge structure 12. The ridge structure 12 may be integrated with the cavity 10, or may be separately processed and formed, and then fixedly connected to the channel 160. In addition, a plurality of ridge structures 12 in the plurality of channels 160 are connected at a position of communication of the plurality of channels 160. For example, the plurality of ridge structures 12 may be integrally formed.

For example, each ridge structure 12 includes a plurality of sub-ridge structures 120, and the plurality of sub-ridge structures 120 are successively connected along a length extension direction M of the channel 160. For example, FIG. 2 shows a case in which the ridge structure 12 includes two sub-ridge structures 120. The two sub-ridge structures 120 are respectively a first sub-ridge structure 121 and a second sub-ridge structure 122. Based on this, the first sub-ridge structures 121 of the plurality of ridge structures 12 are connected, to implement a connection of the plurality of ridge structures 12.

The plurality of sub-ridge structures 120 include top surfaces 123 away from the second surface P2, and along a direction N away from the position of communication of the plurality of channels 160, heights of the top surfaces 123 of the plurality of sub-ridge structures 120 relative to the second surface P2 decrease successively, and the top surfaces 123 of the plurality of sub-ridge structures 120 form a plurality of steps. For example, a top surface of the second sub-ridge structure 122 is lower than a top surface of the first sub-ridge structure 121, and two steps are formed on the top surface of the first sub-ridge structure 121 and the top surface of the second sub-ridge structure 122. The structure design may be used to adjust impedance matching of the waveguide isolator 1.

In addition, a width direction of the sub-ridge structure 120 is perpendicular to the direction N, and widths of the plurality of sub-ridge structures 120 successively decrease along the direction N. For example, a width of the second sub-ridge structure 122 is less than a width of the first sub-ridge structure 121, and the structure design is also used to adjust impedance matching of the waveguide isolator 1.

In addition, a size of the ridge structure 12 is adjusted. For example, a shape of the sub-ridge structure 120 is a cuboid, and a length, the width, and a height of the sub-ridge structure 120 may be adjusted, to adjust impedance matching of the waveguide isolator 1, thereby helping expand a bandwidth of an operating frequency of the device.

Refer to FIG. 2 and FIG. 3. The ferrite 13 is arranged on the ridge structure 12, and the ferrite 13 has a magnetic rotation characteristic, so that the radio frequency signal is unidirectionally transmitted in the resonant cavity in the form of the ridge waveguide.

For example, the plurality of ridge structures 12 in the plurality of channels 160 are connected, and the ferrite 13 may be arranged at a joint of the plurality of ridge structures 12. In this way, the radio frequency signal may be unidirectionally transmitted, through the joint of the plurality of ridge structures 12, from a resonant cavity in which one ridge structure 12 is located to a resonant cavity in which another ridge structure 12 is located.

Refer to FIG. 4. The permanent magnet 14 is arranged on the second surface P2 of the cavity 10, and the ferrite 13 may be magnetized under the action of a magnetic field of the permanent magnet 14, so that the ferrite 13 maintains the magnetic rotation characteristic.

For example, a groove is provided on the second surface P2 of the cavity 10, and the permanent magnet 14 may be arranged in the groove. In addition, along the thickness direction of the cavity 10, the permanent magnet 14 and the ferrite 13 are arranged opposite to each other, with the cavity 10 and the ridge structure 12 disposed between the permanent magnet 14 and the ferrite 13.

In comparison with the use of a plurality of ferrites and a plurality of permanent magnets in a related technology, in the foregoing embodiment of this application, only one ferrite 13 and one permanent magnet 14 are used. Therefore, preparation costs of the device are low and assembly is simple.

Still refer to FIG. 3 and FIG. 4. An example in which the chamber 16 includes three channels 160 is used. Orthographic projections of the three channels 160 on the second surface P2 may be Y-shaped, and the three channels 160 are respectively a first channel 161, a second channel 162, and a third channel 163. Ports 164 are provided in the first channel 161 and the second channel 162, and the port 164 extends through the cavity 10. Therefore, the port 164 may also be observed on the second surface P2 of the cavity 10, and a wave-absorbing load structure 17 is arranged in the third channel 163.

In a process in which the waveguide isolator 1 transmits the radio frequency signal, for example, when the waveguide isolator 1 is used to transmit the radio frequency signal, the radio frequency signal may be input from the port 164 of the first channel 161, transmitted to the joint of the plurality of ridge structures 12 through the first channel 161 (the resonant cavity in the form of the ridge waveguide), unidirectionally transmitted to the second channel 162 (the resonant cavity in the form of the ridge waveguide) under the action of the ferrite 13 and the permanent magnet 14, and output from the port 164 of the second channel 162. The transmission link may be referred to as a “transmit link” of the waveguide isolator 1.

For another example, when the waveguide isolator 1 is used to receive the radio frequency signal, the radio frequency signal may be input from the port 164 of the second channel 162, transmitted to the joint of the plurality of ridge structures 12 through the second channel 162 (the resonant cavity in the form of the ridge waveguide), unidirectionally transmitted to the first channel 161 (the resonant cavity in the form of the ridge waveguide) under the action of the ferrite 13 and the permanent magnet 14, and output from the port 164 of the first channel 161. The transmission link may be referred to as a “receive link” of the waveguide isolator 1.

In the process in which the waveguide isolator 1 transmits or receives the radio frequency signal, all radio frequency signals reflected back by the ports 164 of the first channel 161 and the second channel 162 may be absorbed and consumed by the wave-absorbing load structure 17 in the third channel 163, thereby implementing reverse isolation of the radio frequency signals.

Still refer to FIG. 2 and FIG. 3. The tuning member 15 is arranged on the ridge structure 12, and the tuning member 15 is spaced apart from the ferrite 13. For example, one tuning member 15 is arranged on each sub-ridge structure 120, the tuning member 15 includes a top surface 150 away from the second surface P2, and the top surface 150 of the tuning member 15 is higher than the top surface 123 of the sub-ridge structure 120. In other words, a height of the top surface 150 of the tuning member 15 is greater than the height of the top surface 123 of the sub-ridge structure 120.

The tuning member 15 is arranged on the ridge structure 12. In this way, the tuning member 15 is coupled to the ridge structure 12. The tuning member 15 is introduced into the resonant cavity in the form of the ridge waveguide in which the ridge structure 12 is located. This is equivalent to a case in which the tuning member 15 is coupled to the waveguide isolator 1. The tuning member 15 may introduce an in-band resonance point, to generate a quasi-transverse electromagnetic mode (TEM) resonance. FIG. 5 is a diagram of an equivalent circuit of a resonance generation mechanism of the tuning member 15 according to an embodiment of this application. An example in which the chamber 16 includes three channels 160 is used. Ground capacitance C may be generated between the tuning member 15 on the ridge structure 12 in each channel 160 and the ground, the tuning member 15 may generate self-inductance L1, and mutual inductance L2 may be further generated between tuning members 15 in different channels 160. This is equivalent to a case in which the ground capacitance C, the self-inductance L1, and the mutual inductance L2 are connected in parallel in an equivalent circuit of the resonant cavity in the form of the ridge waveguide, so that a resonator is connected in parallel in the equivalent circuit of the resonant cavity in the form of the ridge waveguide. The tuning member 15 and the resonant cavity in the form of the ridge waveguide may achieve a multi-resonance effect, thereby facilitating adjustment of a frequency of the radio frequency signal transmitted by the waveguide isolator 1, and helping expand the bandwidth of the operating frequency. Therefore, a problem that a waveguide isolator needs to be independently developed for each frequency band is resolved, and a quantity of product codes is reduced.

In addition, the height of the top surface 150 of the tuning member 15 is adjusted to adjust a height of the top surface 150 of the tuning member 15 relative to the top surface 123 of the sub-ridge structure 120, so that a resonance frequency of the tuning member 15 may be adjusted, and the frequency of the radio frequency signal transmitted by the waveguide isolator 1 may be adjusted, thereby helping expand the bandwidth of the operating frequency.

In addition, a coupling amount between the tuning member 15 and the ridge structure 12 may be further adjusted by adjusting the size of the ridge structure 12, so that a coupling amount between the tuning member 15 and the waveguide isolator 1 may be adjusted, and the frequency of the radio frequency signal transmitted by the waveguide isolator 1 may be adjusted, thereby helping expand the bandwidth of the operating frequency.

In some embodiments, one or more tuning members 15 may be arranged on the ridge structure 12 in each channel 160, and each tuning member 15 may introduce one in-band resonance point. It may be understood that, a larger quantity of tuning members 15 arranged on each ridge structure 12 indicates more introduced in-band resonance points, and a clearer multi-resonance effect in the resonant cavity in the form of the ridge waveguide. This helps expand the bandwidth of the operating frequency.

In some embodiments, with reference to FIG. 2 and FIG. 3, a plurality of tuning members 15 are arranged on the ridge structure 12, and the plurality of tuning members 15 may be coupled through the ridge structure 12, so that the coupling amount between the tuning member 15 and the waveguide isolator 1 may be increased, thereby helping expand the bandwidth of the operating frequency.

In addition, the plurality of sub-ridge structures 120 of each ridge structure 12 form a plurality of steps. A plurality of tuning members 15 on a same ridge structure 12 may be arranged on a same step, or may be arranged on different steps. This is not limited in embodiments of this application.

For example, with reference to FIG. 2, one tuning member 15 is arranged on the step formed by the first sub-ridge structure 121, and one tuning member 15 is arranged on the step formed by the second sub-ridge structure 122.

In some embodiments, with reference to FIG. 2 and FIG. 3, for the plurality of tuning members 15 on the same ridge structure 12, a coupling amount between the plurality of tuning members 15 may be further adjusted by adjusting a spacing between the tuning members 15.

It is assumed that a wavelength of the radio frequency signal transmitted by the waveguide isolator 1 is λ, and on the same ridge structure 12, a spacing between two adjacent tuning members 15 is less than or equal to λ/4 along a direction parallel to the second surface P2. A spacing between a tuning member 15 that is in the plurality of tuning members 15 and that is closest to the ferrite 13 and the ferrite 13 is less than or equal to λ/4, to ensure that the coupling amount between the plurality of tuning members 15 is large enough, so as to meet a requirement for expanding the bandwidth of the operating frequency.

Next, several manners of connecting the tuning member 15 to the ridge structure 12 are described.

In some embodiments, with reference to FIG. 2, the tuning member 15 may be movably connected to the ridge structure 12, to facilitate adjustment of the height of the top surface 150 of the tuning member 15, and adjustment of a vertical distance between the top surface 150 of the tuning member 15 and the top surface 123 of the sub-ridge structure 120, so that the resonance frequency of the tuning member 15 may be adjusted.

For example, with reference to FIG. 3 and FIG. 4, the tuning member 15 may be a screw, a threaded hole is provided on the ridge structure 12, the threaded hole extends through the cavity 10, the tuning member 15 is screwed into the threaded hole, and a screwing direction of the tuning member 15 is perpendicular to an electric field direction (parallel to the first surface P1) in the resonant cavity in the form of the ridge waveguide. Therefore, the tuning member 15 may be observed on the second surface P2 of the cavity 10. A height of the tuning member 15 may be adjusted by rotating the tuning member 15.

In addition, an end portion of the tuning member 15 close to the second surface P2 is connected to a nut 18. After the height of the tuning member 15 is adjusted, the nut 18 may be configured to fasten the tuning member 15, to avoid a change in the height of the tuning member 15 caused by rotation of the tuning member 15 in the threaded hole.

The foregoing tuning member 15 is threadedly connected to the ridge structure 12. This is highly feasible for engineering implementation and is suitable for mass production.

For example, the tuning member 15 may alternatively be a cylinder, a through hole is provided on the ridge structure 12, and an interference fit is achieved between the tuning member 15 and the through hole, so that a friction force between the tuning member 15 and the through hole is large. A depth by which the tuning member 15 extends into the through hole may be adjusted by applying an external force, to adjust the height of the tuning member 15.

For example, with reference to FIG. 2 and FIG. 3, a shape of an orthographic projection of the tuning member 15 on the second surface P2 is a circle. In some other examples, the shape of the orthographic projection of the tuning member 15 on the second surface P2 may alternatively be a polygon. For example, the polygon may be a triangle, a quadrilateral, a pentagon, or a hexagon. The quadrilateral may be a rectangle or a square.

In some other embodiments, the tuning member 15 may be fixedly connected to the ridge structure 12. For example, the tuning member 15 is obtained through machining on the ridge structure 12. The tuning member 15 and the ridge structure 12 are integrally formed. This is also highly feasible for engineering implementation and is suitable for mass production.

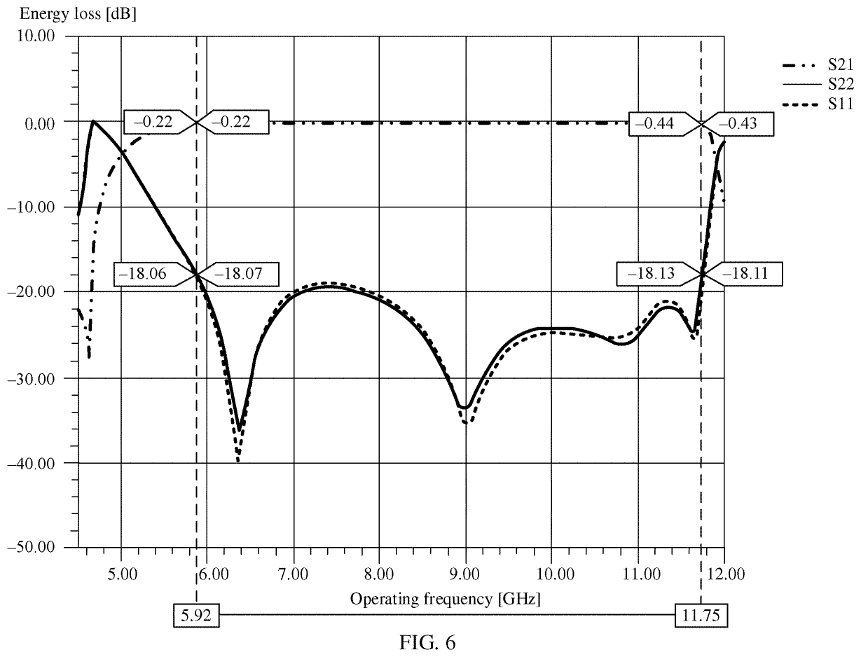

FIG. 6 is a curve diagram of a simulated scattering (S) parameter of the waveguide isolator 1 according to an embodiment of this application. An abscissa of the curve diagram indicates the operating frequency of the device in a unit of “GHz”, and an ordinate indicates an energy loss in a unit of “dB”.

Using the port 164 of the first channel 161 as an input port of a signal and the port 164 of the second channel 162 as an output port of the signal, a curve S21 is a forward transmission coefficient from the port 164 of the first channel 161 to the port 164 of the second channel 162 when the port 164 of the second channel 162 is matched. A value of an ordinate corresponding to the curve S21 is “an insertion loss”. A value of the insertion loss is less than 0 dB, and an ideal value of the insertion loss is 0 dB. A larger value of the insertion loss may be preferred, representing higher transmission efficiency of the signal.

An example in which the value of the insertion loss is greater than or equal to −0.44 dB is used. When the curve S21 is relatively flat, a bandwidth of an operating frequency corresponding to the curve S21 ranges from 5.92 GHz to 11.75 GHz, and a relative bandwidth thereof may reach 66.7%, which is increased to more than 150% of a relative bandwidth of an existing device.

A curve S22 is a reflection coefficient of the port 164 of the second channel 162 when the port 164 of the first channel 161 is matched. A value of an ordinate corresponding to the curve S22 is an “output return loss”, that is, how much energy is reflected back from the port 164 of the second channel 162. A smaller value of the output return loss may be preferred. For example, when the bandwidth of the operating frequency ranges from 5.92 GHz to 11.75 GHz, the output return loss corresponding to the curve S22 is less than or equal to −18 dB.

A curve S11 is a reflection coefficient of the port 164 of the first channel 161 when the port 164 of the second channel 162 is matched. A value of an ordinate corresponding to the curve S11 is an “input return loss”, that is, how much energy is reflected back from the port 164 of the first channel 161. A smaller value of the input return loss may be preferred. For example, when the bandwidth of the operating frequency ranges from 5.92 GHz to 11.75 GHz, the input return loss corresponding to the curve S11 is less than or equal to −18 dB.

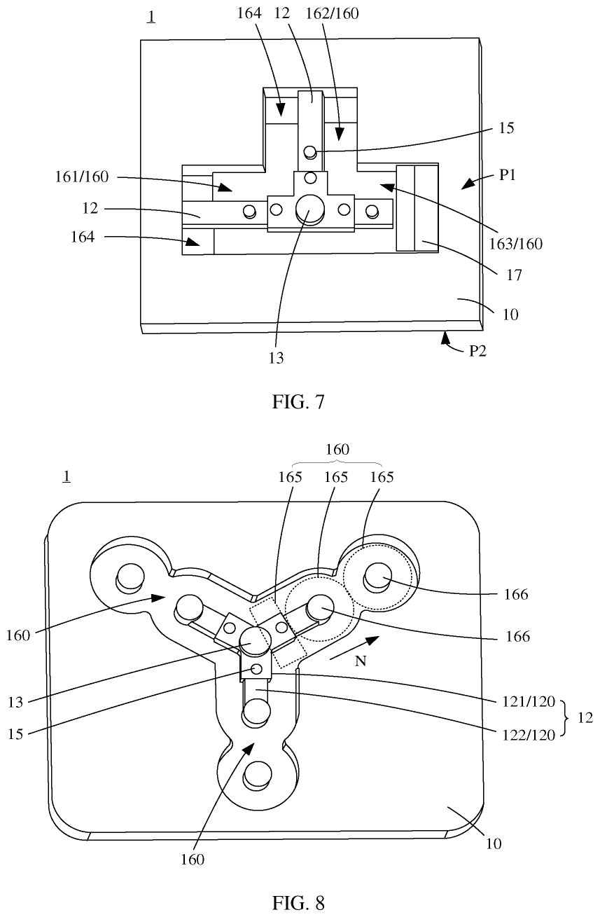

Some embodiments of this application further provide a waveguide isolator. FIG. 7 is another three-dimensional structural diagram of a waveguide isolator according to an embodiment of this application.

Refer to FIG. 7. An internal structure of the waveguide isolator 1 is substantially the same as that of the waveguide isolator 1 in FIG. 2. A difference lies in that orthographic projections of the three channels 160, that is, the first channel 161, the second channel 162, and the third channel 163 of the cavity 10, on the second surface P2 are T-shaped, and positions of the ports 164 in the first channel 161 and the second channel 162 are changed, to adapt to an interconnection requirement of the ports 164.

Some embodiments of this application further provide a waveguide isolator. FIG. 8 is still another three-dimensional structural diagram of a waveguide isolator according to an embodiment of this application.

Refer to FIG. 8. A cavity 10 of the waveguide isolator 1 includes three channels 160, and each channel 160 includes a plurality of sub-resonant cavities 165 that are in communication with each other. In at least two sub-resonant cavities 165 that are in communication with each other, a ridge structure 12 and a tuning member 15 are arranged in one sub-resonant cavity 165, a resonant member 166 is arranged in another sub-resonant cavity 165, and the resonant member 166 is connected to the ridge structure 12 in the sub-resonant cavities 165 that are in communication.

For example, each channel 160 includes three sub-resonant cavities 165 that are in communication in sequence. Along a direction N away from a position of communication of the plurality of channels 160, a first sub-ridge structure 121 and a tuning member 15 are arranged in a first sub-resonant cavity, a second sub-ridge structure 122 and a resonant member 166 are arranged in a second sub-resonant cavity, the resonant member 166 is connected to the second sub-ridge structure 122, and only a resonant member 166 is arranged in a third sub-resonant cavity.

The first sub-ridge structure 121 and the second sub-ridge structure 122 are connected to form the ridge structure 12. Therefore, the resonant member 166 in the second sub-resonant cavity is connected to the ridge structure 12. Inductive coupling between the second sub-resonant cavity and the first sub-resonant cavity is implemented through the ridge structure 12. This helps expand a bandwidth of an operating frequency.

It may be understood that the resonant member 166 in the second sub-resonant cavity is not connected to the resonant member 166 in the third sub-resonant cavity, and inductive coupling is implemented between the two sub-resonant cavities through air.

Still refer to FIG. 8. A shape of the resonant member 166 is a cylinder, and a shape of the sub-resonant cavity 165 in which the resonant member 166 is located is also substantially a cylinder. The resonant member 166 and the sub-resonant cavity 165 may be coaxially arranged, to form a sub-resonant cavity in a form of a coaxial cavity.

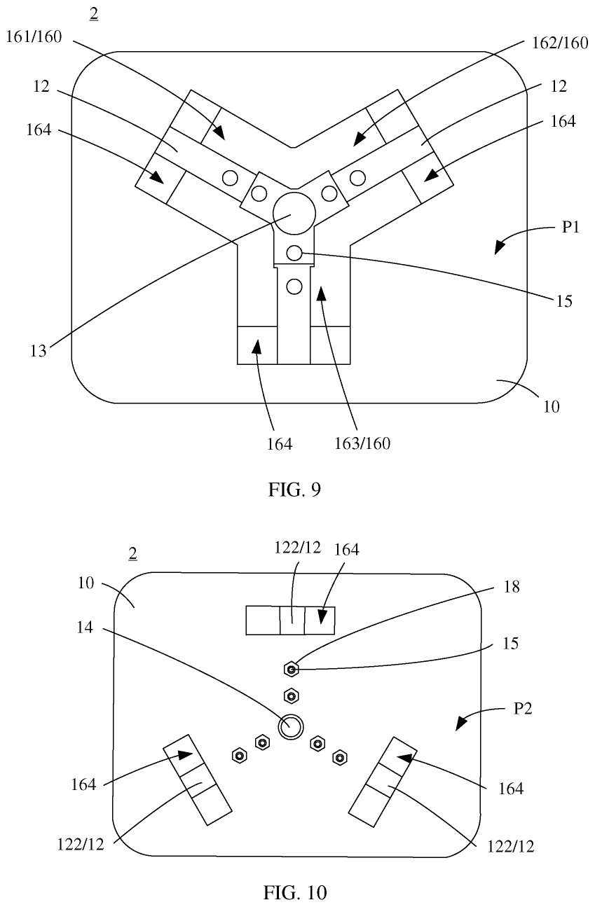

Some embodiments of this application further provide a waveguide circulator. FIG. 9 is a top view of a waveguide circulator according to an embodiment of this application. FIG. 10 is a bottom view of a waveguide circulator according to an embodiment of this application.

Refer to FIG. 9 and FIG. 10. An internal structure of the waveguide circulator 2 is basically the same as that of the waveguide isolator 1 in FIG. 1 to FIG. 4. A difference lies in that each of the three channels 160, that is, the first channel 161, the second channel 162, and the third channel 163 of the cavity 10, is provided with one port 164, and the port 164 extends through the cavity 10. Therefore, the three ports 164 may be observed on the second surface P2 of the cavity 10, and the waveguide circulator 2 is a multi-port device.

In a process in which the waveguide circulator 2 transmits or receives a radio frequency signal, the radio frequency signal is input to the port 164 of any one of the first channel 161, the second channel 162, and the third channel 163. The radio frequency signal may be unidirectionally transmitted to any other channel in a determined order under the action of the ferrite 13 and the permanent magnet 14, and output through the port 164 of the channel.

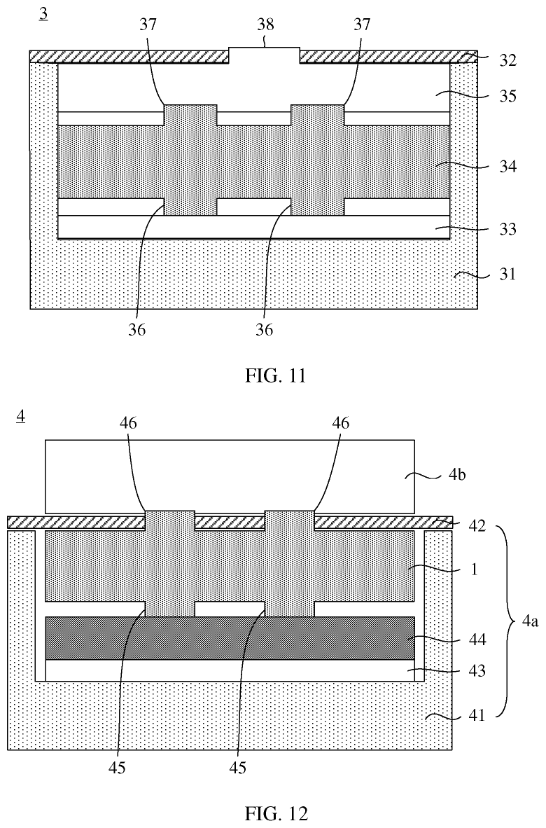

Some embodiments of this application further provide a microwave outdoor unit (ODU). FIG. 11 is a diagram of a structure of a microwave outdoor unit according to an embodiment of this application.

Refer to FIG. 11. The microwave outdoor unit 3 is an outdoor module that processes, transmits, and receives a radio frequency signal, and is a core unit of a microwave point-to-point backhaul communication system.

The microwave outdoor unit 3 includes a lower box body 31, a box cover 32, a circuit board 33, a shielding cover 34, a duplexer 35, and the waveguide isolator 1 described above. The box cover 32 is arranged on the lower box body 31. The box cover 32 and the lower box body 31 form a container for accommodating a device. The circuit board 33, the shielding cover 34, the duplexer 35, and the waveguide isolator 1 are all arranged in the container.

The circuit board 33 is arranged in the lower box body 31, the shielding cover 34 is arranged on the circuit board 33, and a signal transmission link of the circuit board 33 is connected to the shielding cover 34 through a port 36. The waveguide isolator 1 may be integrated onto the shielding cover 34.

The duplexer 35 is arranged on the shielding cover 34. The duplexer 35 is connected to the shielding cover 34 through a port 37. The duplexer 35 is further connected to the box cover 32. A common port 38 is provided on the box cover 32. The common port 38 is used as an antenna port. Transmission and receiving of a signal of the duplexer 35 are both implemented through the common port 38.

In a process in which the microwave outdoor unit 3 transmits a radio frequency signal, the radio frequency signal is output from the circuit board 33, transmitted to the waveguide isolator 1 on the shielding cover 34 through the port 36, transmitted to the duplexer 35 through the port 37, and finally transmitted through the common port 38 by using an external antenna.

In a process in which the microwave outdoor unit 3 receives a radio frequency signal, the radio frequency signal is received through the external antenna. The radio frequency signal is input to the duplexer 35 through the common port 38, transmitted to the waveguide isolator 1 on the shielding cover 34 through the port 37, and transmitted to the circuit board 33 through the port 36.

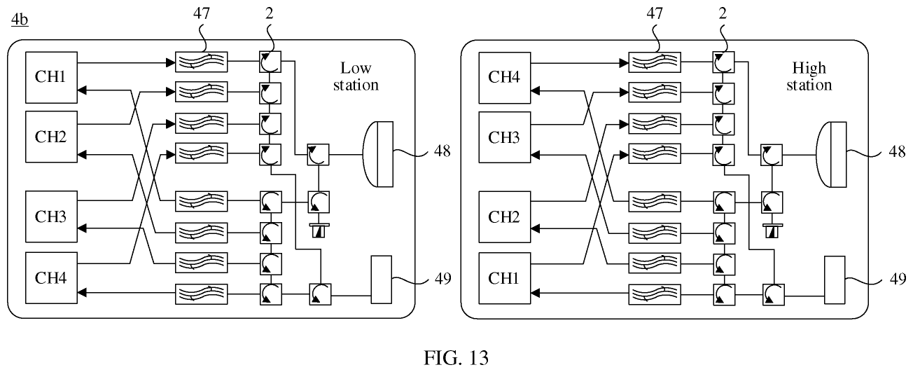

Some embodiments of this application further provide a long-haul (LH) microwave transmission device. FIG. 12 is a diagram of a structure of a long-haul microwave transmission device according to an embodiment of this application.

Refer to FIG. 12. The long-haul microwave transmission device 4 is used in a long-haul microwave communication transmission scenario, is usually in a low frequency band (for example, 6 GHz to 11 GHz) of microwaves, and has performance features such as multi-channel, large-capacity, and long-haul transmission.

In terms of a product form, the long-haul microwave transmission device 4 uses a design in which a microwave radio frequency unit (RFU) 4a is separated from a microwave branching unit (BU) 4b, so that multi-channel frequencies can be flexibly combined, and limited frequency resources in a low frequency band microwave are fully used, thereby achieving a high link capacity.

The microwave radio frequency unit 4a includes a lower box body 41, a box cover 42, a circuit board 43, a shielding cover 44, and the waveguide isolator 1 described above. The box cover 42 is arranged on the lower box body 41. The box cover 42 and the lower box body 41 form a container for accommodating a device. The circuit board 43, the shielding cover 44, and the waveguide isolator 1 are all arranged in the container.

The circuit board 43 is arranged in the lower box body 41, the shielding cover 44 is arranged on the circuit board 43, and a signal transmission link of the circuit board 43 is connected to the shielding cover 44.

The waveguide isolator 1 is arranged on the shielding cover 44, and the waveguide isolator 1 is connected to the shielding cover 44 through a port 45. The waveguide isolator 1 is further connected to the box cover 42. A port 46 is provided on the box cover 42. Transmission and receiving of a signal of the microwave radio frequency unit 4a are both implemented through the port 46.

In a process in which the long-haul microwave transmission device 4 transmits a radio frequency signal, the radio frequency signal is transmitted from the circuit board 43 to the shielding cover 44, transmitted to the waveguide isolator 1 through the port 45, and finally transmitted through the port 46.

In a process in which the long-haul microwave transmission device 4 receives a radio frequency signal, the radio frequency signal is input to the waveguide isolator 1 through the port 46, transmitted to the shielding cover 44 through the port 45, and transmitted from the shielding cover 44 to the circuit board 43.

Still refer to FIG. 12. The microwave branching unit 4b is arranged on the microwave radio frequency unit 4a, and the microwave branching unit 4b is connected to the waveguide isolator 1 through the box cover 42. For example, the microwave branching unit 4b is connected to the waveguide isolator 1 through the port 46.

FIG. 13 is a diagram of an architecture of the microwave branching unit 4b according to an embodiment of this application.

Refer to FIG. 13. The microwave branching unit 4b includes a low station and a high station. A frequency at which the low station receives a signal is lower than a frequency at which the low station transmits a signal, and a frequency at which the high station receives a signal is higher than a frequency at which the high station transmits a signal. The low station or the high station includes the waveguide circulator 2, the duplexer 47, the antenna 48, and the circuit board 49 described above.

For example, the low station and the high station both have four signal channels, which are respectively CH1, CH2, CH3, and CH4. The signal channels CH1 and CH2 are connected to two ports 46 of one microwave radio frequency unit 4a, and the signal channels CH3 and CH4 are connected to two ports 46 of another microwave radio frequency unit 4a.

Each signal channel is connected to two duplexers 47 to transmit and receive signals respectively.

Each duplexer 47 is further connected to the antenna 48 through a plurality of waveguide circulators 2. The plurality of waveguide circulators 2 are further connected to the circuit board 49.

In a process in which the long-haul microwave transmission device 4 transmits a radio frequency signal, the radio frequency signal is input from the microwave radio frequency unit 4a to the signal channel through the port 46, and transmitted to the waveguide circulator 2 through the duplexer 47. The plurality of waveguide circulators 2 unidirectionally transmit the signal to the antenna 48 in a determined order, and finally implement transmission of the radio frequency signal.

In a process in which the long-haul microwave transmission device 4 receives a radio frequency signal, the antenna 48 receives the radio frequency signal and transmits the radio frequency signal to the waveguide circulator 2. The plurality of waveguide circulators 2 unidirectionally transmit the signal to the duplexer 47 in a determined order, and finally output the signal to the microwave radio frequency unit 4a through the signal channel and the port 46.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1.-20. (canceled)

21. A waveguide device, comprising:
a body, comprising a first surface and a second surface that are opposite to each other, wherein a chamber extends from the first surface;
a cover plate arranged on the first surface and covering the chamber;
a ridge structure arranged in the chamber;
a ferrite arranged on the ridge structure;
a permanent magnet arranged on the second surface; and
a tuning member arranged on the ridge structure and spaced apart from the ferrite, wherein the tuning member comprises a top surface that is farthest away from the second surface, the ridge structure comprises a top surface that is farthest away from the second surface, and the top surface of the tuning member is higher over the second surface than the top surface of the ridge structure.

22. The waveguide device according to claim 21, wherein the chamber comprises a plurality of channels, and ends of the plurality of channels are in communication with each other;
wherein each of the channels is provided with one ridge structure, and a plurality of ridge structures are connected at a position of communication of the plurality of channels; and
wherein the tuning member is arranged on the ridge structure.

23. The waveguide device according to claim 22, wherein the ridge structure comprises a plurality of sub-ridge structures, and the plurality of sub-ridge structures are successively connected along a length extension direction of the channel;
wherein the plurality of sub-ridge structures comprise top surfaces that are farthest away from the second surface, and along a direction away from the position of communication of the plurality of channels, heights of the top surfaces of the plurality of sub-ridge structures relative to the second surface decrease successively, and the top surfaces of the plurality of sub-ridge structures form a plurality of steps; and
wherein a plurality of tuning members are arranged on the ridge structure, and the plurality of tuning members are arranged on a same step, or the plurality of tuning members are arranged on different steps.

24. The waveguide device according to claim 22, wherein a plurality of tuning members are arranged on the ridge structure, and a spacing between two adjacent tuning members is less than or equal to λ/4 along a direction parallel to the second surface;
wherein the ferrite is arranged at a joint of the plurality of ridge structures, and a spacing between a tuning member that is in the plurality of tuning members on the ridge structures and that is closest to the ferrite and the ferrite is less than or equal to λ/4 along the direction parallel to the second surface; and
wherein the waveguide device is configured to transmit a radio frequency signal, wherein λ is a wavelength of the radio frequency signal.

25. The waveguide device according to claim 21, wherein the tuning member is movably connected to the ridge structure, to adjust a vertical distance between the top surface of the tuning member and the top surface of the ridge structure.

26. The waveguide device according to claim 25, wherein the tuning member is threadedly connected to the ridge structure.

27. The waveguide device according to claim 21, wherein the tuning member and the ridge structure are integrally formed.

28. The waveguide device according to claim 21, wherein a shape of an orthographic projection of the tuning member on the second surface comprises a polygon or a circle.

29. The waveguide device according to claim 21, wherein the chamber comprises a plurality of channels, ends of the plurality of channels are in communication with each other, and the channels comprise a plurality of resonant cavities that are in communication with each other; and
wherein in at least two resonant cavities that are in communication with each other, one resonant cavity is provided with the ridge structure and the tuning member, the other resonant cavity is provided with a resonant member, and the resonant member is connected to the ridge structure.

30. The waveguide device according to claim 29, wherein a shape of the resonant member comprises a cylinder, a shape of the resonant cavity in which the resonant member is located comprises a cylinder, and the resonant member and the resonant cavity are coaxially arranged.

31. The waveguide device according to claim 21, wherein the chamber comprises three channels; and
orthographic projections of the three channels on the second surface are Y-shaped or T-shaped.

32. A device, comprising:
a microwave radio frequency unit, comprising a lower box body, a box cover, a circuit board, a shielding cover, and a waveguide isolator, wherein the box cover is arranged on the lower box body, the box cover and the lower box body form a container, the circuit board, the shielding cover, and the waveguide isolator are arranged in the container, the shielding cover and the waveguide isolator are successively arranged on the circuit board, a duplexer is connected to the box cover, the waveguide isolator is integrated onto the shielding cover, and the waveguide isolator is connected to the box cover;
a microwave branching unit, arranged on the microwave radio frequency unit, wherein the microwave branching unit is connected to the waveguide isolator through the box cover; and
a waveguide device comprising:
a body, comprising a first surface and a second surface that are opposite to each other, wherein a chamber extends from the first surface;
a cover plate arranged on the first surface and covering the chamber;
a ridge structure arranged in the chamber;
a ferrite arranged on the ridge structure;
a permanent magnet arranged on the second surface; and
a tuning member arranged on the ridge structure and spaced apart from the ferrite,
wherein the tuning member comprises a top surface that is farthest away from the second surface, the ridge structure comprises a top surface that is farthest away from the second surface, and the top surface of the tuning member is higher over the second surface than the top surface of the ridge structure.

33. The device according to claim 32, wherein the chamber comprises a plurality of channels, and ends of the plurality of channels are in communication with each other;
wherein each of the channels is provided with one ridge structure, and a plurality of ridge structures are connected at a position of communication of the plurality of channels; and
wherein the tuning member is arranged on the ridge structure.

34. The device according to claim 33, wherein the ridge structure comprises a plurality of sub-ridge structures, and the plurality of sub-ridge structures are successively connected along a length extension direction of the channel;
wherein the plurality of sub-ridge structures comprise top surfaces that are farthest away from the second surface, and along a direction away from the position of communication of the plurality of channels, heights of the top surfaces of the plurality of sub-ridge structures relative to the second surface decrease successively, and the top surfaces of the plurality of sub-ridge structures form a plurality of steps; and
wherein a plurality of tuning members are arranged on the ridge structure, and the plurality of tuning members are arranged on a same step, or the plurality of tuning members are arranged on different steps.

35. The device according to claim 34, wherein the plurality of tuning members are arranged on the ridge structure, and a spacing between two adjacent tuning members is less than or equal to λ/4 along a direction parallel to the second surface;
wherein the ferrite is arranged at a joint of the plurality of ridge structures, and a spacing between a tuning member that is in the plurality of tuning members on the ridge structures and that is closest to the ferrite and the ferrite is less than or equal to λ/4 along the direction parallel to the second surface; and
wherein the waveguide device is configured to transmit a radio frequency signal, wherein λ is a wavelength of the radio frequency signal.

36. The device according to claim 32, wherein the tuning member is movably connected to the ridge structure, to adjust a vertical distance between the top surface of the tuning member and the top surface of the ridge structure.

37. The device according to claim 32, wherein the chamber comprises three channels; and
wherein orthographic projections of the three channels on the second surface are Y-shaped or T-shaped.

38. A device, comprising:
a microwave radio frequency unit; and
a microwave branching unit, arranged on the microwave radio frequency unit, wherein the microwave branching unit comprises a waveguide circulator,
wherein the waveguide circulator comprises a waveguide device, and a chamber in a body of the waveguide device comprises a plurality of channels, ends of the plurality of channels are in communication with each other, each of the channels is provided with one port, and each port extends through the body;
wherein the waveguide device comprises:
the body, comprising a first surface and a second surface that are opposite to each other, wherein the chamber extends from the first surface;
a cover plate arranged on the first surface and covering the chamber;
a ridge structure arranged in the chamber;
a ferrite arranged on the ridge structure;
a permanent magnet arranged on the second surface; and
a tuning member arranged on the ridge structure and spaced apart from the ferrite,
wherein the tuning member comprises a top surface that is farthest away from the second surface, the ridge structure comprises a top surface that is farthest away from the second surface, and the top surface of the tuning member is higher over the second surface than the top surface of the ridge structure.

39. The device according to claim 38, wherein the chamber comprises a plurality of channels, and ends of the plurality of channels are in communication with each other;
wherein each of the channels is provided with one ridge structure, and a plurality of ridge structures are connected at a position of communication of the plurality of channels; and
wherein the tuning member is arranged on the ridge structure.

40. The device according to claim 39, wherein the ridge structure comprises a plurality of sub-ridge structures, and the plurality of sub-ridge structures are successively connected along a length extension direction of the channel;
wherein the plurality of sub-ridge structures comprise top surfaces that are farthest away from the second surface, and along a direction away from the position of communication of the plurality of channels, heights of the top surfaces of the plurality of sub-ridge structures relative to the second surface decrease successively, and the top surfaces of the plurality of sub-ridge structures form a plurality of steps; and
wherein a plurality of tuning members are arranged on the ridge structure, and the plurality of tuning members are arranged on a same step, or the plurality of tuning members are arranged on different steps.
